(19) United States
(12) Patent Application Publication
(10) Pub. No.: US 2014/0078404 A1
(43) Pub. Date: Mar. 20, 2014

(54) METHOD AND SYSTEM FOR AUTOMATICALLY ADJUSTING TELEVISION VOLUME, TELEVISION SET AND TELEVISION REMOTE CONTROLLER

(71) Applicant: Quatius Limited, Kowloon (HK)

(72) Inventor: Ka Wing Cheung, Hong Kong (HK)

(21) Appl. No.: 13/907,192

(22) Filed: May 31, 2013

(30) Foreign Application Priority Data
Sep. 14, 2012 (CN) 201210343847.0

(51) Int. Cl. H04N 5/60

(52) U.S. Cl. CPC H04N 5/60
USPC 348/734

(57) ABSTRACT

A method and system for automatically adjusting television volume, and a television set or a remote controller are disclosed. In the method and system, it judges whether the environmental sound surrounding the television includes the same sound component with a preset phone ringing, and thereby identifies whether there is an incoming call when the user is watching television, and if there is an incoming call, an operation of reducing television volume is automatically performed, without the user's manual operation of reducing the TV volume. When receiving a call when watching TV, the user does not need to find a remote controller and look for the phone, which brings great convenience for the user. The system can be provided on the television, and can also be provided on a television remote controller or a controller, to automatically adjust the television volume according to the phone ringing.

### CROSS-REFERENCE TO RELATED APPLICATION

This application claims priority to Chinese Patent Application No. 201210343847.0, filed on Sep. 14, 2012, the contents of which are incorporated by reference in its entirety.

### FIELD OF THE INVENTION

The present invention relates to the field of television technology, and more particularly to an automatic television volume adjusting method, an automatic television volume adjusting system, a television set and a television remote controller.

### BACKGROUND OF THE INVENTION

It is very common that a user may receive a phone call while watching television. Usually after hearing the ringing of the mobile phone or landline phone, the user will have to turn down the television volume before answering the phone, to avoid the television sound from affecting the phone communication.

Normally, the television volume adjusting method is regulating a volume adjusting button on the television, or directly adjusting a volume adjusting button on the television remote controller or controller. Thus, when receiving a call, the user need to use the volume adjusting button on the remote controller or on a television set to achieve television volume adjustment. On one hand, the user needs to answer the phone, on the other hand he needs to look around for the remote controller, and if the remote controller is not around the user, it will be in a flurry; or the user need to walk to the front of a television set to regulate the volume adjusting button on a television set, which is not convenient. It could lead to delaying too much time and hanging up incoming calls, miss the time to answer the phone, and if miss an important call, it is more likely to lead to a significant loss of the user.

### SUMMARY OF THE INVENTION

Directing to the problems exiting in the prior art, it is an object of the present invention is to provide a method for automatically adjusting television volume, which could conveniently detect whether there is telephone communication and then automatically adjust the television volume, and an automatic television volume adjusting system, and a television set or television remote controller with the automatic television volume adjusting system.

According to an aspect of the present invention, a method for automatically adjusting television volume, includes the steps of:

detecting environmental sound surrounding the television;

judging whether the environmental sound contains the same sound component with preset phone ringing; and

executing an operation of reducing the television volume if yes.

According to another aspect of the invention, a system for automatically adjusting television volume includes:

a sound detection module, configured to detect environmental sound surrounding the television;

a sound processing module, configured to judge whether the environmental sound contains the same sound component with the preset phone ringing; and

a volume adjusting module, configured to execute an operation of reducing television volume when the environmental sound contains the same sound component with the preset phone ringing.

According to a further aspect of the invention, a television set includes the above mentioned system for automatically adjusting television volume

According to still a further aspect of the invention, a television remote controller includes above mentioned system for automatically adjusting television volume.

The automatic television volume adjusting method and system of the present invention is by judging whether the environmental sound surrounding the television contains the same sound component with preset phone ringing, and thereby identifying whether there is an incoming call when the user is watching television, and if there is an incoming call, an operation of reducing television volume is automatically executed, without the user's manual operation of reducing the TV volume, which is very convenient. Using the present invention, when receiving a call when watching TV, the user does not need to find the remote controller while looking for the phone, which brings great convenience for the user. The automatic television volume adjusting system can be provided on a television set, and can also be provided on a television remote controller or a controller, to automatically adjust the television volume according to the phone ringing, which brings great convenience for user.

### BRIEF DESCRIPTION OF THE DRAWINGS

FIG. 1 is a flow-process diagram of an automatic television volume adjusting method according to one embodiment of the present invention.

FIG. 2 is a flow-process diagram of an automatic television volume adjusting method according to one embodiment of the present invention.

FIG. 3 is a structural schematic diagram of an automatic television volume adjusting system according to one embodiment of the present invention.

FIG. 4 is a structural schematic diagram of a sound processing module of an automatic television volume adjusting system according to one embodiment of the present invention.

FIG. 5 is a structural schematic diagram of a sound processing module of an automatic television volume adjusting system according to one embodiment of the present invention.

FIG. 6 is a structural schematic diagram of an automatic television volume adjusting system according to one embodiment of the present invention.

FIG. 7 is a structural schematic diagram of a radio wave processing module of an automatic television volume adjusting system according to one embodiment of the present invention.

FIG. 8 is a structural schematic diagram of a radio wave processing module of an automatic television volume adjusting system according to one embodiment of the present invention.

### DETAILED DESCRIPTION OF THE PREFERRED EMBODIMENTS

With reference to FIG. 1, it is a flow-process diagram of an automatic television volume adjusting method according to the first embodiment of the present invention.

The automatic television volume adjusting method comprises the following steps of:

S101, detecting environmental sound surrounding the television;

S102, judging whether the environmental sound contains the same sound component with preset phone ringing; and

S103, executing an operation of reducing the television volume when the judging result is yes.

In the step of S101, detect environmental sound surrounding the television.

The environmental sound surrounding the television is acquired by a sound sensor, and the sound sensor may transform the detected sound signal to an electrical signal or extract various sound characteristics (such as frequency, tone, rhythm etc.) of the sound signal, and then analyze and judge the environmental sound by the electrical signal or various waveform characteristics.

Preferably, the environmental sound surrounding the television refers to the environmental sound in special range surrounding the television, and the special range may be sensing range of the sound sensor, or to set detection range based on actual need, and the sound exceeds the sensing range can not be detected because the volume is too small, or to exclude the other detected sound that exceeds the special range.

In the step of S102, judge whether the environmental sound contains the same sound component with the preset phone ringing.

The environmental sound is composed of various detected sound components, so it needs to judge whether there is an incoming call according to a special sound component which is same with the phone ringing.

The preset ringing includes user's pre-recorded ringing as well as the system default ringing, including songs, voice, or traditional phone ringing with rhythm, etc. The user could pre-record their phone ringing by recording tools as a reference phone ringing for judgment.

Two methods for judging the sound component of the environmental sound are proposed as followings:

One method is: acquiring sound characteristics of the environmental sound, and comparing the sound characteristics of the environmental sound with those of the preset phone ringing; judging whether the environmental sound contains the same sound component with preset phone ringing according to level of agreement between the sound characteristics of the environmental sound and those of the preset phone ringing.

The sound characteristics of the environmental sound and the preset phone ringing include volume changes, frequency, tone, rhythm etc. to distinguish different sound characteristics. The preset phone ringing includes the phone ringing that the user pre-records and the system own default ringing. The phone ringing that the user pre-records includes songs, voices, noise or traditional phone ringing etc., and the system may have some traditional and common phone ringing as the default ringing.

In the present embodiment method, compare the environmental sound and preset phone ringing, and then judge according to the level of agreement between the two, if the level of agreement between the two exceeds a preset value, then judge the environmental sound contains the same sound component with the preset phone ringing, otherwise the judgment of the contrary.

The level of agreement between the sound characteristics of the environmental sound and those of the preset phone ringing may be the level of agreement of a single sound characteristic, such as if the level of agreement of the rhythm is higher than the preset value, it could be directly judged that the environmental sound contains the same sound component with the preset phone ringing; or may be the level of agreement of multiple sound characteristic combination, for example, if the level of agreement of tone and rhythm are both higher than the preset value, it could be judged that the environmental sound contains the same sound component with the preset phone ringing.

Another embodiment method is: converting the environmental sound into a first electrical signal; acquiring signal characteristics of the first electrical signal, and comparing the signal characteristics of the first electrical signal with that of a second electrical signal converted from the preset phone ringing; judging whether the environmental sound contains the same sound component with the preset phone ringing according to level of agreement between the signal characteristics of the first electrical signal and that of the second electrical signal.

In the embodiment, the sound sensor may convert the detected environmental sound into an electrical signal, marked as a first electrical signal; and the preset phone ringing is converted to an electrical signal in the same way, marked as a second electrical signal. Compare the signal characteristics of the first electrical signal with that of the second electrical signal, and if the level of agreement between the two signal characteristics exceeds the preset value, then judge the environmental sound contains the same sound component with the preset phone ringing, otherwise the judgment of the contrary. Wherein, the signal characteristics include signal waveform, frequency, amplitude, etc.

The level of agreement of the signal characteristics may be the level of agreement of a single signal characteristic, such as when the level of agreement of waveform exceeds the preset value, directly judge the environmental sound contains the same sound component with the preset phone ringing; or it may also be the level of agreement of several signal characteristic combination, such as the level of agreement of the frequency and amplitude both exceed the preset value, judge the environmental sound contains the same sound component with the preset phone ringing.

When judge the environmental sound contains the same sound component with the preset phone ringing, in the step of S103, execute an operation of reducing the television volume; otherwise, do not execute the operation of reducing the television volume.

Preferably, when executing the operation of reducing the television volume, reduce the television volume at a preset progress of volume adjustment until muteness. For example, reduce the television volume at a speed of two ranks per second; another example is to gradually reduce the television volume and mute completely within 5 seconds.

When executing the operation of reducing television volume, a volume control menu may be displayed on a television screen and display the volume value at present, enabling the user more intuitive feeling for volume reduction. Preferably, when beginning to execute the operation of reducing the television volume, if receiving a key command of the remote controller, then stop reducing the television volume. The key command of the television remote controller may be a special key, such as a volume increasing key, or an arbitrary key. Further, when stop reducing the television volume, adjusting the television volume back to the volume before executing the operation of reducing the television volume. In this way, the user may conveniently and recover the reduced television sound quickly by the remote controller.

Preferably, it may be provided an option on whether to activate the function of automatic television volume adjusting on the television or on the television remote controller. When the user chooses to open the function of television volume automatic adjustment, activate the automatic television volume adjusting method and system of the present invention, and detect the environmental sound surrounding the television or radio wave signal to proceed with the television volume automatic adjustment. When the user does not open the function of television volume automatic adjustment, do not activate the automatic television volume adjusting method and system of the present invention, even though there is an incoming call, it does not trigger the television volume automatic adjustment.

The automatic television volume adjusting method of the present invention is by judging whether environmental sound surrounding the television contains the same sound component with preset phone ringing, and thereby identifying whether there is an incoming call when the user is watching television, and if there is an incoming call, an operation of reducing television volume is automatically executed, without the user's manual operation of reducing the TV volume, which is very convenient. Using the present invention, when receiving a call when watching TV, the user does not need to find the remote controller while looking for the phone, which brings great convenience for the user. The automatic television volume adjusting function can be provided on a television set, and can also be provided on a television remote controller or a control, to automatically adjust the television volume according to the phone ringing.

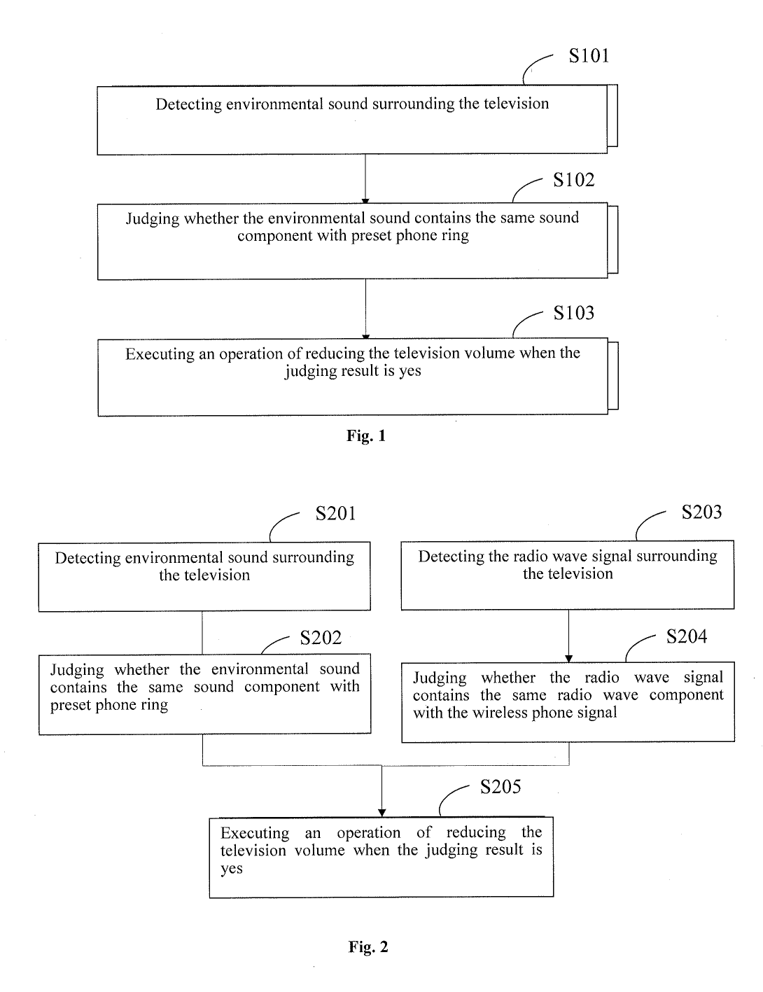

With further reference to FIG. 2, it is a flow-process diagram of an automatic television volume adjusting method according to the second embodiment of the present invention.

The difference between automatic television volume adjusting method of the present embodiment and that of the first embodiment is that: when executing the step S201 detecting the environmental sound surrounding the television and the step S202 judging whether the environmental sound contains the same sound component with the preset phone ringing, further execute the following steps of:

S203, further detecting the radio wave signal surrounding the television;

S204, judging whether the radio wave signal contains the same radio wave component with the wireless phone signal;

When the environmental sound contains the same sound component with the preset phone ringing, or the radio wave signal contains the same radio wave component with the wireless phone signal, then get into step S205, executing the operation of reducing the television volume.

In the step S203 detecting the radio wave signal surrounding the television, the radio wave signal contains all the radio wave signal surrounding the television, which may be composed of a variety of different radio waves. According to the same radio wave component therein with the wireless phone signal, judge whether there is an incoming call.

Two methods for judging the radio wave component in the radio wave signal are provided as followings:

one method is: acquiring signal characteristics of the radio wave signal, and comparing the signal characteristics of the radio wave signal with those of the wireless phone signal; judging whether the radio wave signal contains the same radio wave component with the wireless phone signal according to level of agreement between the signal characteristics of the radio wave signal and those of the wireless phone signal.

Wherein, the signal characteristics of the radio wave signal and the wireless phone signal include standard, frequency etc. signal characteristics characterizing the radio wave.

In the present embodiment, compare the signal characteristics of the radio wave signal and those of the wireless phone signal, and then judge according to the level of agreement between the two, if the level of agreement between the two exceeds a preset value, then judge the radio wave signal contains the same radio wave component with the wireless phone signal, otherwise the judgement of the contrary.

The level of agreement between signal characteristics of the radio wave signal and those of the preset phone ringing may be the level of agreement of a single signal characteristic, such as if the level of agreement of the frequency is higher than the preset value, it could be directly judged the radio wave signal contains the same radio wave component with the wireless phone signal; or it may be the level of agreement of multiple signal characteristics, for example, if the levels of agreement of standard and frequency are both higher than the preset value, it could be judged that the radio wave signal contains the same radio wave component with the wireless phone signal.

Another method is, converting the radio wave signal into a third electrical signal; acquiring the signal characteristics of the third electrical signal, and comparing the signal characteristics of the third electrical signal with those of a forth electrical signal converted from the wireless phone signal; judging whether the radio wave signal contains the same radio wave component with the wireless phone signal according to level of agreement between the signal characteristics of the third electrical signal and that of the forth electrical signal.

In the embodiment, a radio wave sensor may convert the radio wave signal surrounding the television into an electrical signal, marked as a third electrical signal; and the wireless phone signal is converted into electrical signal in the same way, marked as a forth electrical signal. Compare the signal characteristics of the third electrical signal with those of the forth electrical signal, and if the level of agreement between the two signal characteristics exceeds the preset value, judge the radio wave signal contains the same radio wave component with the wireless phone signal, otherwise the judgement of the contrary. Wherein, the signal characteristics of the electrical signal include signal waveform, frequency, amplitude, etc.

The level of agreement of the signal characteristics may be the level of agreement of a single signal characteristic, such as when the level of agreement of frequency exceeds the preset value, directly judge the radio wave signal contains the same radio wave component with the wireless phone signal; or it also may be the level of agreement of several signal characteristics combination, such as the level of agreement of the standard and frequency both exceeds the preset value, judge the radio wave signal contains the same radio wave component with the wireless phone signal.

In the present embodiment, further detect the radio wave signal surrounding the television. According to the radio wave, judge whether there is an incoming call, and when judging whether there is an incoming call, automatically execute the operation of reducing the television volume. In addition to ringing indicating an incoming call, the wireless phone may also prompts by “vibration” of vibration mode, so when the wireless telephone has been switched to the vibration mode, the user may detect the radio wave to monitor calls from wireless phone by the present embodiment, achieving the treatment of automatically reducing the television volume.

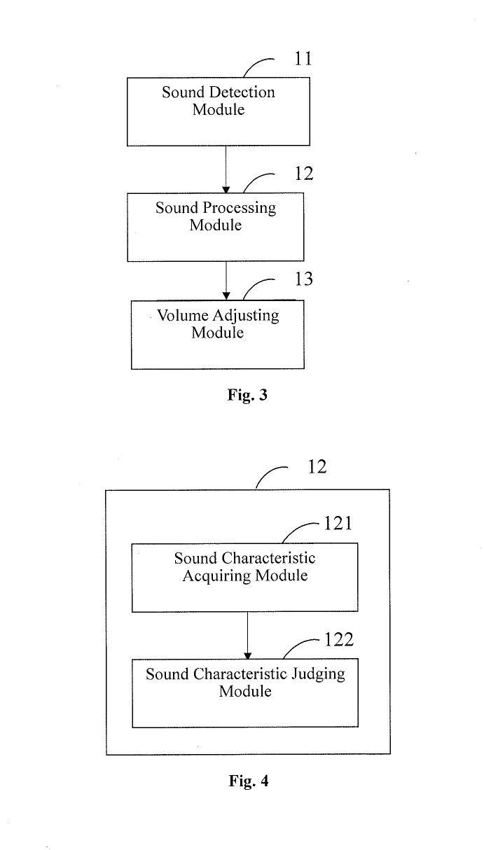

With reference to FIG. 3, it is a structural schematic diagram of an automatic television volume adjusting system according to the first embodiment of the present invention.

The automatic television volume adjusting system includes:

a sound detection module 11, configured to detect environmental sound surrounding the television;

a sound processing module 12, configured to judge whether the environmental sound contains the same sound component with the preset phone ringing; and

a volume adjusting module 13, configured to execute an operation of reducing television volume when the environmental sound contains the same sound component with the preset phone ringing.

Wherein, a sound sensor acquires the environmental sound surrounding the television, and the sound sensor may transform detected sound signal into an electrical signal or extract various sound characteristics (such as frequency, tone, rhythm etc.) of the sound signal, and then analyze and judge the environmental sound by the electrical signal or various waveform characteristics.

Preferably, the environmental sound surrounding the television refers to the environmental sound in special range surrounding the television, and the special range may be sensing range of the sound sensor, or to set detection range based on actual need by the sound detection module 11, and the sound exceeds the sensing range can not be sensed because the volume is too small, or to exclude the other detected sound that exceeds the special range by setting the sound detection module 11.

The sound processing module 12 judges whether the environmental sound contains the same sound component with the preset phone ringing.

The environmental sound is composed of various detected sound components, so the sound processing module 12 judges whether there is an incoming call according to a special sound component therein the same with the phone ringing.

The preset ringing includes user's pre-recorded ringing as well as the system default ringing, including songs, voice, or traditional phone ringing with rhythm, etc. The user could pre-record their phone ringing by recording tools as a reference phone ringing for judgement.

With reference to FIG. 4, it is a structural schematic diagram a sound processing module of an automatic television volume adjusting system according to one embodiment of the present invention;

As a preferred embodiment, the sound processing module 12 includes:

a sound characteristic acquiring module 121, configured to acquire sound characteristics of the environmental sound;

a sound characteristic judging module 122, configured to compare the sound characteristics of the environmental sound with that of the preset phone ringing, and judge whether the environmental sound contains the same sound component with the preset phone ringing according to the level of agreement of the sound characteristics of the environmental sound and the preset phone ringing.

Wherein, the sound characteristics of the environmental sound and the preset phone ringing comprise volume changes, frequency, tone, rhythm etc. to distinguish different sound characteristics. The preset phone ringing includes the phone ringing that the user pre-records and the system own default ringing. The phone ringing that the user pre-records includes songs, voices, noise or traditional phone ringing etc., and the system may have some traditional and common phone ringing as the default ringing.

The sound characteristics judging module 122 compares the sound characteristics of the environmental sound with those of the preset phone ringing, and judges according the level of agreement of the two, and if the level of agreement between the two exceeds a preset value, judge the environmental sound contains the same sound component with the preset phone ringing, otherwise the judgment of the contrary.

The level of agreement between the sound characteristics of the environmental sound and that of the preset phone ringing may be the level of agreement of a single sound characteristic, such as if the level of agreement of the rhythm is higher than the preset value, it could be directly judged the environmental sound contains the same sound component with the preset phone ringing; or may be the level of agreement of multiple sound characteristics combination, for example, if the levels of agreement of tone and rhythm are both higher than the preset value, it could be judged the environmental sound contains the same sound component with the preset phone ringing.

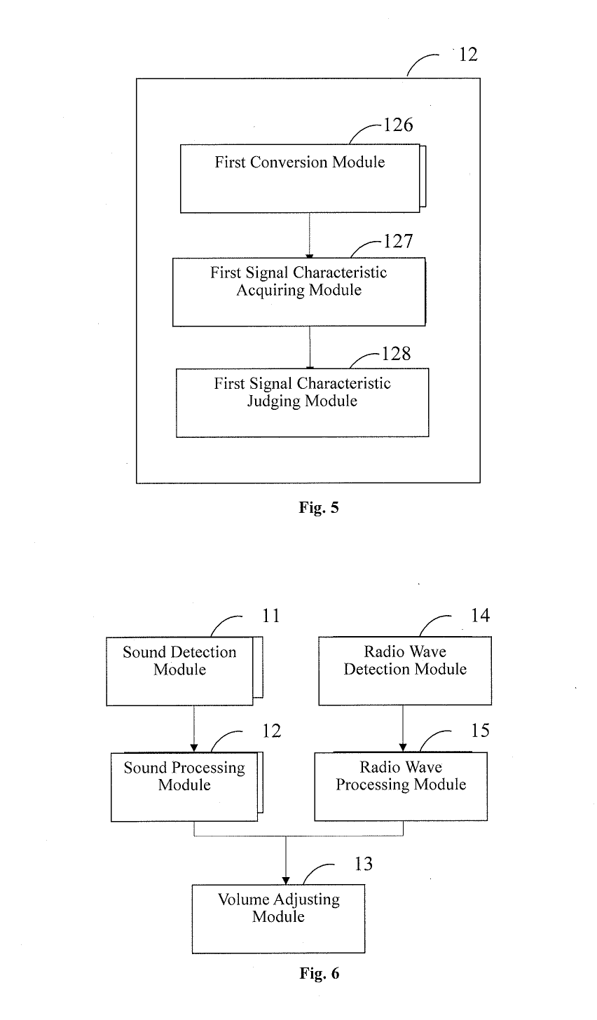

With reference to FIG. 5, it is a structural schematic diagram of a sound processing module of an automatic television volume adjusting system according to another embodiment of the present invention.

As another preferred embodiment, the sound processing module 12 includes:

A first conversion module 126, configured to convert the environmental sound into the first electrical signal;

A first signal characteristic acquiring module 127, configured to acquire the signal characteristics of the first electrical signal;

A first signal characteristic judging module 128, configured to compare the signal characteristics of the first electrical signal with that of a second electrical signal converted by the preset phone ringing, and determine whether the environmental sound contains the same sound component with the preset phone ringing according to level of agreement between the signal characteristics of the first electrical signal and that of the second electrical signal.

In the present embodiment, the first conversion module 126 may convert the detected environmental sound into the electrical signal by the sound sensor, marked as a first electrical signal; and the preset phone ringing is transformed into an electrical signal by the same way, marked as a second electrical signal. The first signal characteristics judging module 128 compares the signal characteristics of the first electrical signal with those of the second electrical signal, and if the level of agreement between the two signal characteristics exceeds the preset value, judges the environmental sound contains the same sound component with the preset phone ringing, otherwise the judgment of the contrary. Wherein, the signal characteristics include signal waveform, frequency, amplitude, etc.

The level of agreement of the signal characteristics may be the level of agreement of a single signal characteristic, such as when the degree of agreement of waveform exceeds the preset value, directly judge the environmental sound contains the same sound component with the preset phone ringing; or it also may be the level of agreement of several signal characteristic combination, such as the levels of agreement of the frequency and amplitude both exceed the preset value, judge the environmental sound contains the same sound component with the preset phone ringing.

When the sound processing module 12 judges the environmental sound contains the same sound component with the preset phone ringing, the volume adjusting module 13 will execute an operation of reducing the television volume; otherwise, it will not execute the operation of reducing the television volume.

Preferably, when the volume adjusting module 13 executes the operation of reducing the television volume, it reduces the television volume through a preset progress of volume adjustment until muteness. For example, reduce the television volume at a speed of two ranks per second; another example is to gradually reduce the television volume and mute completely within 5 seconds.

When the sound adjusting module 13 executes the operation of reducing television volume, a volume control menu may be displayed on a television screen and display the volume value at present, enabling the user more intuitive feeling for volume reduction. Preferably, when the sound adjusting module 13 begins to execute the operation of reducing the television volume, if receiving a key command of the remote controller, then stop reducing the television volume. The key command of the remote controller may be a special key, such as a volume increasing key, or an arbitrary key. Furthermore, when stop reducing the television volume, the sound adjusting module 13 adjusts the television volume back to the volume before executing the operation of reducing the television volume. In this way, the user may conveniently and quickly recover the reduced television sound by the remote controller.

In one embodiment, the automatic television volume adjusting system of the present invention may provide an option on whether to activate the function of automatic television volume adjusting on the television or on the television remote controller. When the user chooses to open the function of television volume automatic adjustment, activate the automatic television volume adjusting method and system of the present invention, and detect the environmental sound surrounding the television or the radio wave signal to proceed with the television volume automatic adjustment; and when the user does not open the function of automatic television volume adjusting, do not activate the automatic television volume adjusting method and system of the present invention, even though there is an incoming call, it does not trigger the television volume automatic adjustment.

The automatic television volume adjusting system of the present invention is by judging whether environmental sound surrounding the television contains the same sound component with preset phone ringing sound, and thereby identifying whether there is an incoming call when the user is watching television, and if there is an incoming call, an operation of reducing television volume is automatically executed, without the user's manual operation of reducing the TV volume, which is very convenient. Using the present invention, when receiving a call when watching TV, the user no longer need to find the remote controller while looking for the phone, which brings great convenience for the user. The automatic television volume adjusting function can be provided on a television set, and can also be provided on a television remote controller or a controller, to automatically adjust the television volume according to the phone ringing.

With reference to FIG. 6, it is a structural schematic diagram of an automatic television volume adjusting system according to the second embodiment of the present invention.

The difference between the automatic television volume adjusting system of the embodiment and that of the first embodiment is that: further comprising the radio wave detection module 14 and radio wave processing module 15, the radio wave detection module 14 is used to detect the radio wave surrounding the television; the radio wave processing module 15 is used to determine whether the radio wave signal contains the same radio wave component with the wireless phone signal; the volume adjusting module 13 further executes an operation of reducing the television volume when the radio wave signal contains the same radio wave component with the wireless phone signal.

Wherein, when the radio wave detection module 14 detects the radio wave signal surrounding the television, the radio wave signal contains all the radio wave signals surrounding the television, which may be composed of a variety of different radio waves. According to the radio wave component therein the same with the wireless phone signal, judge whether there is an incoming call.

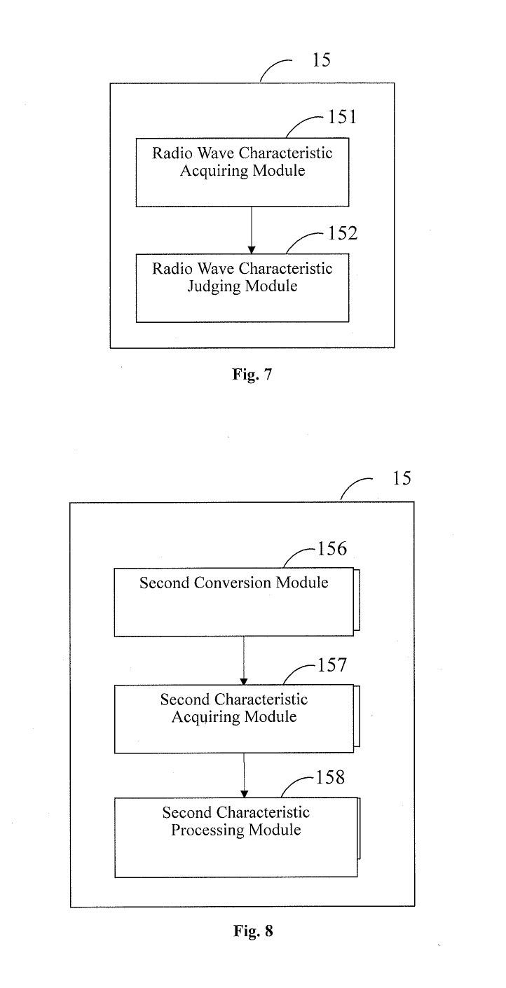

With reference to FIG. 7, it is a structural schematic diagram of a radio wave processing module of an automatic television volume adjusting system according to one embodiment of the present invention.

In a preferred embodiment, the radio wave processing module 15 includes:

a radio wave characteristic acquiring module 151, configured to acquire the signal characteristics of the radio wave signal;

a radio wave characteristic judging module 152, configured to compare the signal characteristics of the radio wave signal with that of the wireless phone signal, and judge whether the radio wave signal contains the same radio wave signal with the wireless phone signal according to the level of agreement of the signal characteristics of the radio wave signal and those of the wireless phone signal.

The signal characteristics of the radio wave signal and the wireless phone signal include standard, frequency etc. signal characteristics characterizing the radio wave.

In the present embodiment, the radio wave characteristic judging module 152 compares the signal characteristics of the radio wave signal and those of the wireless phone signal, and then judges according to the level of agreement between the two, if the level of agreement between the two exceeds a preset value, then judges the radio wave signal contains the same radio wave component with the wireless phone signal, otherwise the judgment of the contrary.

The level of agreement between signal characteristics of the radio wave signal and those of the preset phone ringing may be the level of agreement of a single signal characteristic, such as if the degree of agreement of the frequency is higher than the preset value, it could be directly judged that the radio wave signal contains the same radio wave component with the wireless phone signal; or it may be the level of agreement of multiple signal characteristics, for example, if the levels of agreement of standard and frequency is both higher than the preset value, it could be judged the radio wave signal contains the same radio wave component with the wireless phone signal.

With reference to FIG. 8, it is a structural schematic diagram of a radio wave processing module of an automatic television volume adjusting system according to another embodiment of the present invention.

In another preferred embodiment, the radio wave processing module 15 includes:

a second conversion module 156, configured to convert the radio wave signal into a third electrical signal;

a second characteristic acquiring module 157, configured to acquire the signal characteristics of the third electrical signal;

a second characteristics judging module 158, configured to compare the signal characteristics of the third electrical signal with those of a forth electrical signal converted by the wireless phone signal, and judge whether the radio wave signal contains the same radio wave component with the wireless phone signal according to level of agreement between the signal characteristics of the third electrical signal and those of the forth electrical signal.

In the embodiment, the second conversion module 156 may convert the detected radio wave signal surrounding the television into an electrical signal by a radio wave sensor, marked as a third electrical signal; and the wireless phone signal is converted to an electrical signal in the same way, marked as a forth electrical signal. The second characteristics judging module 158 compares the signal characteristics of the third electrical signal with those of the forth electrical signal, and if the level of agreement between the two signal characteristics exceeds the preset value, determines the radio wave signal contains the same radio wave component with the wireless phone signal, otherwise the judgment of the contrary. Wherein, the signal characteristics of the electrical signal include signal waveform, frequency, amplitude, etc.

The level of agreement of the signal characteristics may be the level of agreement of a single signal characteristic, such as when the level of agreement of frequency exceeds the preset value, directly judge the radio wave signal contains the same radio wave component with the wireless phone signal; or it also may be the level of agreement of several signal characteristics combination, such as the levels of agreement of the standard and frequency both exceed the preset value, judge the radio wave signal contains the same radio wave component with the wireless phone signal.

In the present embodiment, further detect the radio wave signal surrounding the television. According to the radio wave, judge whether there is an incoming call, and when judging there is an incoming call, automatically execute the operation of reducing the television volume. In addition to ring indicating an incoming call, the wireless phone may also prompts by “vibration” of vibration mode, so when the wireless telephone has been switched to the vibration mode, the user may detect the radio wave to monitor calls from wireless phone by the present embodiment, achieving the treatment of automatically reducing the television volume.

A person skilled in the art can understand that the whole or parts of the above mentioned flow process and the corresponding system may be completed by related hardware instructed by computer program which may be stored in a computer readable storage medium, and when the program is executed, it may include the above mentioned flow process. Wherein, the computer readable storage medium may be a disk, an optical disk, a read-only memory (ROM), or a random access memory (RAM) etc.

The present invention also provides a television set, and a television set includes the automatic television volume adjusting system of the present invention. The present invention also provides a television remote controller, and the television remote controller also includes the automatic television volume adjusting system of the present invention.

The television and television remote controller includes the automatic television volume adjusting system of the present invention, so by judging whether the environmental sound surrounding the television contains the same sound component with preset phone ringing, and whether the radio wave contains the same radio wave component with the wireless phone ringing signal, thereby identify whether there is an incoming call when the user is watching television, and if there is an incoming call, an operation of reducing television volume is automatically executed, without the user's manual operation of reducing the TV volume, which is very convenient, and it may be applied to landline or wireless phone calls detection. Using the present invention, when receiving a call when watching TV, the user does not need to find the remote controller while looking for the phone, which brings great convenience for the user. The automatic television volume adjusting system can be provided on a television set, and can also be provided on a television remote controller or a control, to automatically adjust the television volume according to the phone ringing.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A method for automatically adjusting television volume, comprising:
detecting environmental sound surrounding a television;
judging whether the environmental sound contains the same sound component with a preset phone ringing; and
executing an operation of reducing the television volume when the judging result is yes.

2. The method of claim 1, wherein the step of judging whether the environmental sound contains the same sound component with a preset phone ringing comprises:
acquiring sound characteristics of the environmental sound, and comparing the sound characteristics of the environmental sound with that of the preset phone ringing;
judging whether the environmental sound contains the same sound component with the preset phone ringing according to level of agreement between the sound characteristics of the environmental sound and that of the preset phone ringing.

3. The method of claim 1, wherein the step of judging whether the environmental sound contains the same sound component with a preset phone ringing comprises:
converting the environmental sound into a first electrical signal;
acquiring signal characteristics of the first electrical signal, and comparing the signal characteristics of the first electrical signal with that of a second electrical signal converted by the preset phone ringing; and
judging whether the environmental sound contains the same sound component with the preset phone ringing according to level of agreement between the signal characteristics of the first electrical signal and that of the second electrical signal.

4. The method of claim 1, further comprising:
detecting radio wave signal surrounding the television;
adjusting whether the radio wave signal contains the same radio wave component with wireless phone signal; and
executing an operation of reducing the television volume when the judging result is yes.

5. The method of claim 4, wherein the step of judging whether the radio wave signal contains the same radio wave component with wireless phone signal comprises:
acquiring signal characteristics of the radio wave signal, and comparing the signal characteristics of the radio wave signal with that of the wireless phone signal;
judging whether the radio wave signal contains the same radio wave component with the wireless phone signal according to level of agreement between the signal characteristic of the radio wave signal and that of the wireless phone signal.

6. The method of claim 4, wherein, the step of judging whether the radio wave signal contains the same radio wave component with wireless phone signal comprises:
converting the radio wave signal to a third electrical signal;
acquiring the signal characteristics of the third electrical signal, and comparing the signal characteristics of the third electrical signal with that of a forth electrical signal converted from the wireless phone signal;
judging whether the radio wave signal contains the same radio wave component with the wireless phone signal according to the level of agreement between the signal characteristics of the third electrical signal and that of the forth electrical signal.

7. The method of claim 1, wherein the step of executing an operation of reducing the television volume comprises:
reducing the television volume through a preset progress of volume adjustment until muteness.

8. The method of claim 1, wherein when executing the operation of reducing the television volume, a volume adjusting menu is displayed on the television screen.

9. The method of claim 1, wherein, after executing the operation of reducing the television volume, if receiving a key command of the remote controller, stopping reducing the television volume.

10. The method of claim 9, wherein adjusting the television volume back to the volume before executing the operation of reducing the television volume when stopping reducing the television volume.

11. A system for automatically adjusting television volume, comprising:
a sound detection module, configured to detect environmental sound surrounding the television;
a sound processing module, configured to judge whether the environmental sound contains the same sound component with a preset phone ringing; and
a volume adjusting module, configured to execute an operation of reducing television volume when the environmental sound contains the same sound component with the preset phone ringing.

12. The system of claim 11, further comprising:
a radio wave detection module, configured to detect radio wave signal surrounding the television; and
a radio wave processing module, configured to judge whether the radio wave signal contains the same radio wave component with wireless phone signal;
wherein the volume adjusting module is further configured to execute an operation of reducing the television volume when the radio wave signal contains the same radio wave component with the wireless phone signal.

13. A television set, comprising the automatic television volume adjusting system of claim 11.

14. A television remote controller, comprising the automatic television volume adjusting system of claim 11.
